(19) United States
(12) Patent Application Publication
(10) Pub. No.: US 2024/0158245 A1
(43) Pub. Date: May 16, 2024

(54) PROCESS FOR THE DEALUMINATION OF ZEOLITIC MATERIALS

(71) Applicant: BASF SE, Ludwigshafen am Rhein (DE)

(72) Inventors: Trees Maria De Baerdemaeker, Ludwigshafen am Rhein (DE); Andrei-Nicolae Parvulescu, Ludwigshafen am Rhein (DE); Faruk Oezkirim, Ludwigshafen am Rhein (DE); Ke Jin, Shanghai (CN); Ulrich Mueller, Neustadt (DE); Alvaro Gordillo Bolonio, Barcelona (ES); Lukasz Karwacki, Ludwigshafen am Rhein (DE)

(21) Appl. No.: 18/550,143

(22) PCT Filed: Mar. 18, 2022
(86) PCT No.: PCT/EP2022/057149

§ 371 Date: Sep. 12, 2023

(30) Foreign Application Priority Data
Mar. 19, 2021 (EP) 21163625.3

(51) Int. Cl. C01B 39/02

(52) U.S. Cl. CPC C01B 39/026

(57) ABSTRACT

This disclosure relates to a process for the dealumination of a zeolitic material including
(1) providing a zeolitic material having a tetravalent element and a trivalent element;
(2) providing an aqueous solution having a pH of less than 0.1;
(3) treating the zeolitic material with the aqueous solution; and
   with an aqueous solution or with a solvent system, wherein the aqueous solution or the solvent system have a pH comprised in the range of from 4 to 10, wherein the pH of the aqueous solution or of the solvent system refers to the pH prior to contacting with the zeolitic material for treatment thereof. This disclosure also relates to a zeolitic material as obtained and/or obtainable according to said process.

### TECHNICAL FIELD

The present invention relates to a process for the dealumination of a zeolitic material as well as to a zeolitic material per se, as obtainable or obtained according to said method.

### INTRODUCTION

Zeolites have many applications in chemical industry, mostly in heterogeneous catalysis in various chemical and petrochemical processes. Generally, they are crystalline aluminosilicates having microporous structure. The special properties of the zeolites are attributed, among others, to their porous structure in the form of a pore system of molecular dimensions which is accessible for molecules depending on their shape and their size. There are numerous known zeolite framework structures which can serve as selective heterogeneous catalysts for several types of applications. The framework type and the chemical composition are responsible for the properties of the zeolite such as ion-exchange capacity, porosity, accessibility, acidity and hydrophilic or hydrophobic properties.

In order to modify the properties of zeolitic materials such as their structure or their composition, post-treatment methods are often employed. Common post-treatment methods include steam treatment, acid treatment, or basic treatment.

Steam treatment is often used to enhance the activity and stability of the zeolite against water vapor for various selective reactions. EP 0 013 433 A1, for example, teaches the use of steam treatment to increase the activity of a zeolite by increasing the Si/Al ratio. This steam treatment not only influences the Si/Al ratio, but also has an impact on the acidic/basic properties and the hydrophilicity/hydrophobicity of the zeolite.

Acid treatment has a similar effect and also leads to dealumination of the zeolite. For such acid treatment, organic acids such as acetic acid, propionic acid, oxalic acid or mineral acids such as hydrochloric acid, nitric acid, sulfuric acid or phosphoric acid are often employed. Reference is made, for example, to WO 02/057181 A2 wherein an acid treatment is carried out in order to increase the hydrophobicity of a zeolitic material.

A combination of steam treatment and acid treatment is described in WO 2009/016153 A2. According to this document, phosphorus-modified molecular sieves having a low Si/Al ratio are subjected to a steam treatment at high temperatures before a leaching step with an acidic solution is carried out to remove Al from the zeolitic framework structure. Steam and acid treatments are also disclosed in WO 2012/137132 A1, which relates to a process for producing an acylation catalyst starting from zeolite beta.

Both the steam treatment and the acid treatment have a significant influence on the properties of the zeolitic material. By subjecting a zeolitic material comprising both tetravalent and trivalent structural components YO₂ and X₂O₃, respectively, to a steam and/or an acid treatment, the YO₂:X₂O₃ molar ratio is increased. However, it was found that the crystallinity of the zeolitic material is decreased by the steam treatment and/or the acid treatment. Therefore, it was found that the steam treatment and the acid treatment both result in a partial transformation of the zeolitic material into an amorphous material. Therefore, although a desired YO₂:X₂O₃ molar ratio can be achieved by the steam treatment or the acid treatment, the obtained zeolitic materials have major disadvantages which, among others, make them uninteresting for commercial use.

WO 2014/060260 A1, on the other hand, relates to a process for the dealumination of a zeolitic material which involves subjecting a zeolitic material to multiple treatment steps with an aqueous acid followed by at least one treatment with a liquid aqueous system having a pH in the range of 5.5 to 8 at elevated temperatures. According to said document, said specific sequence allows for dealumination with a reduced loss in crystallinity.

However, there remains the need of a more time- and cost-efficient method for the dealumination of zeolitic materials, in particular with regard to the number of steps which must be performed for achieving the desired dealumination level, without however jeopardizing the crystallinity of the resulting material.

### DETAILED DESCRIPTION

Therefore, it was an object of the present invention to provide a facile and highly efficient process for the dealumination of a zeolitic material which does not exhibit said disadvantages.

Surprisingly, it was found that a post-treatment process which involves subjecting a zeolitic material comprising YO₂ and X₂O₃ to at least one treatment with a highly acidic aqueous solution having a pH less than 0.1 and at least one treatment with a liquid aqueous system having a pH in the range of 4 to 10 allows for the dealumination of a zeolitic material to a desired degree in fewer steps. In particular, it has quite unexpectedly been found that by using highly concentrated aqueous solutions, dealumination may be achieved in fewer steps without jeopardizing the crystallinity of the resulting material.

Therefore, the present invention relates to a process for the dealumination of a zeolitic material comprising:
(1) providing a zeolitic material having a framework structure comprising Y, X, and O, wherein Y is a tetravalent element and X is a trivalent element;
(2) providing an aqueous solution having a pH of less than 0.1;
(3) treating the zeolitic material provided in (1) with the aqueous solution provided in (2);
(3.i) optionally washing the zeolitic material obtained in (3);
(3.ii) optionally drying the zeolitic material obtained in (3) or (3.i);
(3.iii) optionally calcining the zeolitic material obtained in (3), (3.i), or (3.ii);
(4) treating the zeolitic material obtained in (3), (3.i), (3.ii), or (3.iii) with an aqueous solution or with a solvent system, wherein the aqueous solution or the solvent system have a pH comprised in the range of from 4 to 10, wherein the pH of the aqueous solution or of the solvent system refers to the pH prior to contacting with the zeolitic material for treatment thereof;
(4.i) optionally drying the zeolitic material obtained in (4);
(4.ii) optionally calcining the zeolitic material obtained in (4) or (4.i).

According to the present invention, the pH value of the aqueous solution preferably stands for the pH of the aqueous solution as determined at 20° C.

It is preferred that the zeolitic material provided in (1) contains less than 1 wt.-% of ionic nonframework elements other than H⁺ based on 100 wt.-% of the total amount of Y, X, and O contained in the zeolitic material, more preferably less than 0.5 wt.-%, more preferably less than 0.1 wt.-%, more preferably less than 0.05 wt.-%, more preferably less than 0.01 wt.-%, more preferably less than 0.005 wt.-%, and more preferably less than 0.001 wt.-%. Furthermore, it is preferred that the ionic non-framework elements stand for Na, more preferably for Na and K, more preferably for Li, Na, and K, more preferably for Li, Na, K, and Cs, more preferably for alkali metal cations, more preferably for alkali and alkaline earth metal cations, and more preferably for metal cations.

It is preferred that the zeolitic material provided in (1) contains one or more metals M, wherein the one or more metals M are selected from the group consisting of alkali metals and alkaline earth metals, including mixtures of two or more thereof, more preferably from the group consisting of alkali metals, more preferably from the group consisting of Li, Na, K, Rb, and Cs, including mixtures of two or more thereof, more preferably from the group consisting of Li, Na, and K, including mixtures of two or more thereof, wherein more preferably the one or more metals M comprise Na and/or K, preferably Na, wherein more preferably the one or more metals M consist of Na and/or K, preferably Na. Furthermore, it is preferred that the zeolitic material provided in (1) contains the one or more metals M in an amount ranging from 0.01 to 25 wt.-% based on 100 wt.-% of the total amount of M, Y, X, and O contained in the zeolitic material, more preferably from 0.05 to 20 wt.-%, more preferably from 0.1 to 18 wt.-%, more preferably from 0.5 to 15 wt.-%, more preferably from 1 to 12 wt.-%, more preferably from 2 to 10 wt.-%, more preferably from 3 to 8 wt.-%, and more preferably from 4 to 6 wt.-%.

It is preferred that (3) and (4) optionally including (3.i), (3.ii), (3.iii), (4.i), and/or (4.ii) are repeated at least once with the zeolitic material obtained from step (4), (4.i), or (4.ii), wherein more preferably (3) and (4) optionally including (3.i), (3.ii), (3.iii), (4.i), and/or (4.ii) are repeated 1 to times, more preferably 1 to 8 times, more preferably 1 to 6 times, more preferably 1 to 4 times, more preferably 1 to 3 times, more preferably 1 to 2 times, and wherein more preferably (3) and (4) optionally including (3.i), (3.ii), (3.iii), (4.i), and/or (4.ii) are repeated once.

It is preferred that the framework of the zeolitic material provided in (1) has a Y:X molar ratio comprised in the range of from 1 to 100, more preferably from 1 to 50, more preferably from 2 to 25, more preferably from 3 to 12, and more preferably from 4 to 6.

It is preferred that Y is selected from the group consisting of Si, Sn, Ti, Zr, Ge, and a mixture of two or more thereof, Y more preferably being Si.

It is preferred that X is selected from the group consisting of Al, B, In, Ga, and a mixture of two or more thereof, X more preferably being Al.

It is preferred that the framework-type structure of the zeolitic material provided in (1) is selected from the group consisting of AEI, BEA, CHA, DDR, ERI, FAU, FER, GME, HEU, LEV, MEI, MEL, MFI, MOR, and MWW, including mixed structures of two or more thereof, more preferably from the group consisting of AEI, BEA, CHA, FAU, FER, MFI, MOR, and MWW, including mixed structures of two or more thereof, more preferably from the group consisting of BEA, CHA, and MOR, including mixed structures of two or more thereof, wherein more preferably the zeolitic material provided in (1) has the BEA and/or CHA framework-type structure, preferably the BEA framework-type structure.

It is preferred that wherein the zeolitic material provided in (1) comprises one or more zeolites of the BEA-type framework structure selected from the group consisting of zeolite beta, beta polymorph B, [B—Si—O]—*BEA, Tschernichite, [Ga—Si—O]—*BEA, CIT-6, including mixtures of two or more thereof, wherein more preferably the zeolitic material provided in (1) comprises zeolite beta, wherein more preferably the zeolitic material provided in (1) is zeolite beta.

It is preferred that the pH of the aqueous solution provided in (2) is comprised in the range of from −1 to 0.05, more preferably from −0.8 to 0, more preferably from −0.7 to −0.03, more preferably from −0.6 to −0.05, more preferably from −0.5 to −0.08, more preferably from −0.4 to −0.1, more preferably −0.3 to −0.13, and more preferably from −0.2 to −0.15, wherein preferably, the pH is determined using a glass pH electrode, wherein more preferably the pH is determined using a glass pH electrode according to ISO 23497:2019, wherein more preferably the pH is determined according to DIN 19268.

It is preferred that the aqueous solution provided in (2) comprises one or more acids having a pKₐ value of less than or equal to 2.5, more preferably of less than or equal to 2.3, more preferably of less than or equal to 2, more preferably of less than or equal to 1.8, more preferably of less than or equal to 1.5, more preferably of less than or equal to 1.3, more preferably of less than or equal to 1, more preferably of less than or equal to 0.8, more preferably of less than or equal to 0.5, more preferably of less than or equal to 0.3, more preferably of less than or equal to 0.1, and more preferably of less than or equal to 0.

It is preferred that the one or more acids are selected from the group consisting of mineral and organic acids, including mixtures of two or more thereof, more preferably from the group consisting of mineral acids, including mixtures of two or more thereof, more preferably from the group consisting of HCl, HBr, Hl, HClO, HClO₂, HClO₃, HClO₄, H₂SO₄, HSO₃F, HNO₃, H₃PO₄, HSBF₆, HBF₄, HPF₆, including mixtures of two or more thereof, more preferably from the group consisting of HCl, HBr, HClO₄, H₂SO₄, HSO₃F, HNO₃, H₃PO₄, including mixtures of two or more thereof, more preferably from the group consisting of HCl, HBr, H₂SO₄, HNO₃, H₃PO₄, including mixtures of two or more thereof, more preferably from the group consisting of H₂SO₄, HNO₃, H₃PO₄, including mixtures of two or more thereof, wherein more preferably the aqueous solution provided in (2) comprises HNO₃, wherein more preferably the acid contained in the aqueous solution provided in (2) consists of HNO₃, wherein more preferably the aqueous solution provided in (2) consists of distilled water and HNO₃.

It is preferred that the total concentration of the one or more acids comprised in the aqueous solution provided in (2) is equal to or greater than 0.8 mol/L, wherein more preferably the total concentration of the one or more acids comprised in the aqueous solution provided in (2) is comprised in the range of from 0.8 to 10 mol/L, more preferably of from 1.0 to 10 mol/L, more preferably of from 1.0 to 7.9 mol/L, more preferably of from 1.0 to 6.3 mol/L, more preferably of from 1.1 to 2.5 mol/L, more preferably of from 1.1 to 1.6 mol/L, and more preferably of from 1.1 to 1.4 mol/L.

It is preferred that the molar ratio H₂O:Y of the molar amount of H₂O in the aqueous solution provided in (2) which is used for treating in (3) to the molar amount of Y in the framework structure of the zeolitic material which is treated in (3) is comprised in the range of from 1 to 200, more preferably from 3 to 150, more preferably from 5 to 50, more preferably from 7 to 25, more preferably from 8 to 15, more preferably from 8.5 to 12, more preferably from 9 to 11, and more preferably from 9.5 to 10.5.

It is preferred that the treatment in (3) is conducted at a temperature comprised in the range of from 20 to 100° C., more preferably from 30 to 90° C., more preferably from 40 to 80° C., more preferably from 50 to 70° C., more preferably from 55 to 65° C., more preferably from 58 to 62° C., and more preferably from 59 to 61° C.

It is preferred that the treatment in (3) is conducted for a duration comprised in the range of from to 200 minutes, more preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.

It is preferred that optional washing in (3.i) is performed with distilled water.

It is preferred that optional drying in (3.ii) is conducted at a temperature comprised in the range of from 40 to 200° C., more preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.

It is preferred that optional drying in (3.ii) is conducted for a duration comprised in the range of from 0.25 to 48 hours, more preferably from 0.5 to 36 hours, more preferably from 1 to 30 hours, more preferably from 2 to 24 hours, more preferably from 4 to 20 hours, more preferably from 6 to 18 hours, more preferably from 8 to 16 hours, more preferably from 10 to 14 hours, and more preferably from 11 to 13 hours.

It is preferred that optional calcination in (3.iii) is conducted at a temperature comprised in the range of from 300 to 900° C., more preferably from 350 to 850° C., more preferably from 400 to 800° C., more preferably from 450 to 750° C., more preferably from 500 to 700° C., more preferably from 550 to 650° C., more preferably from 590 to 610° C., and more preferably from 598 to 602° C.

It is preferred that optional calcination in (3.iii) is conducted for a duration comprised in the range of from 1 to 10 hours, more preferably from 2 to 8 hours, more preferably from 3 to 7 hours, more preferably from 4 to 6 hours, and more preferably from 4.5 to 5.5 hours.

It is preferred that the pH of the aqueous solution or of the solvent system employed for the treatment in (4) is comprised in the range of from 4 to 10, more preferably from 5 to 9, more preferably from 6 to 8, more preferably from 6.5 to 7.5, and more preferably from 6.8 to 7.2, wherein the pH of the aqueous solution or of the solvent system refers to the pH prior to contacting with the zeolitic material for treatment thereof.

It is preferred that the solvent system employed in (4) comprises water, wherein more preferably the solvent system employed in (4) consists of distilled water.

It is preferred that treatment in (4) is conducted at a temperature comprised in the range of from to 150° C., more preferably from 40 to 140° C., more preferably from 50 to 130° C., more preferably from 60 to 120° C., more preferably from 70 to 110° C., more preferably from 80 to 100° C., more preferably from 85 to 95° C., and more preferably from 88 to 92° C.

It is preferred that treatment in (4) is conducted for a duration comprised in the range of from 1 to 17 hours, more preferably from 2 to 16 hours, more preferably 3 to 15 hours, more preferably from 5 to 13 hours, more preferably from 6 to 12 hours, more preferably from 7 to 11 hours, more preferably from 8 to 10 hours, and more preferably from 8.5 to 9.5 hours.

It is preferred that the solvent system comprises water, and wherein the molar ratio H₂O:Y of the molar amount of H₂O in the aqueous solution or in the solvent system used for treating in (3) to the molar amount of Y in the framework structure of the zeolitic material which is treated in (3) is comprised in the range of from 1 to 250, more preferably from 2.5 to 200, more preferably from 5 to 150, more preferably from 10 to 100, more preferably from 15 to 50, more preferably from 20 to 30, more preferably from 21 to 26, and more preferably from 22 to 24.

It is preferred that optional drying in (4.i) is conducted at a temperature comprised in the range of from 40 to 200° C., more preferably from 50 to 190° C., more preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.

It is preferred that optional drying in (4.i) is conducted for a duration comprised in the range of from 0.25 to 48 hours, more preferably from 0.5 to 36 hours, more preferably from 1 to 30 hours, more preferably from 2 to 24 hours, more preferably from 4 to 20 hours, more preferably from 6 to 18 hours, more preferably from 8 to 16 hours, more preferably from 10 to 14 hours, and more preferably from 11 to 13 hours.

It is preferred that optional calcination in (4.ii) is conducted at a temperature comprised in the range of from 200 to 1000° C., more preferably from 300 to 900° C., more preferably from 350 to 850° C., more preferably from 400 to 800° C., more preferably from 450 to 750° C., more preferably from 500 to 700° C., more preferably from 550 to 650° C., more preferably from 575 to 625° C., and more preferably 595 to 605° C.

It is preferred that optional calcination in (4.ii) is conducted for a duration comprised in the range of from 1 to 10 hours, more preferably from 2 to 8 hours, more preferably from 3 to 7 hours, more preferably from 4 to 6 hours, and more preferably from 4.5 to 5.5 hours.

It is preferred that the zeolitic material provided in (1) is obtainable or obtained from an organo-template-free synthetic process.

In cases wherein the zeolitic material provided in (1) is obtainable or obtained from an organo-template-free synthetic process, it is preferred that the organo-template-free synthetic process comprises
(A) preparing a mixture comprising one or more sources for YO₂, one or more sources for X₂O₃, and seed crystals comprising one or more zeolitic materials having a BEA-type framework structure; and
(B) crystallizing the mixture obtained in step (A) for forming a zeolitic material having a BEA-type framework structure;
   wherein Y is a tetravalent element, and X is a trivalent element, and
   wherein the mixture provided in step (A) and crystallized in step (B) does not contain an organo-template as structure-directing agent.

It is preferred that the zeolitic material obtained in step (B) comprises one or more alkali metals M, wherein M is more preferably selected from the group consisting of Li, Na, K, Cs, and combinations of two or more thereof, more preferably from the group consisting of Li, Na, K, and combinations of two or more thereof, wherein more preferably the alkali metal M is Na and/or K, even more preferably Na.

It is preferred that Y is selected from the group consisting of Si, Sn, Ti, Zr, Ge, and a mixture of two or more thereof, Y more preferably being Si.

It is preferred that the one or more sources for YO₂ provided in step (A) comprises one or more silicates, more preferably one or more alkali metal silicates, wherein the alkali metal is preferably selected from the group consisting of Li, Na, K, Rb, and Cs, wherein more preferably the alkali metal is Na and/or K, and wherein even more preferably the alkali metal is Na. Furthermore, it is preferred that the one or more sources for YO₂ further comprises one or more silicas in addition to the one or more silicates, more preferably one or more silica hydrosols and/or one or more colloidal silicas, and even more preferably one or more colloidal silicas in addition to the one or more silicates. In particular, it is preferred that the mixture provided in step (A) comprises water glass, more preferably sodium and/or potassium silicate, more preferably sodium silicate.

It is preferred that X is selected from the group consisting of Al, B, In, Ga, and a mixture of two or more thereof, X more preferably being Al.

It is preferred that the one or more sources for X₂O₃ comprises one or more aluminate salts, more preferably an aluminate of an alkali metal, wherein the alkali metal is preferably selected from the group consisting of Li, Na, K, Rb, and Cs, wherein more preferably the alkali metal is Na and/or K, and wherein even more preferably the alkali metal is Na.

It is preferred that the molar ratio YO₂:X₂O₃ of the mixture according to step (A) ranges from 1 to 200, more preferably from 5 to 100, more preferably from 10 to 50, more preferably from 15 to 40, more preferably from 20 to 30, more preferably from 23 to 25, and even more preferably from 23.5 to 24.

It is preferred that the amount of seed crystals comprised in the mixture according to step (A) ranges from 0.1 to 30 wt.-% based on 100 wt.-% of YO₂ in the one or more sources for YO₂, more preferably from 0.5 to 20 wt.-%, more preferably from 1 to 10 wt.-%, more preferably from 1.5 to 5 wt.-%, more preferably from 2 to 4 wt.-%, and even more preferably from 2.5 to 3.5 wt.-%.

It is preferred that wherein the mixture according to step (A) further comprises one or more solvents, wherein said one or more solvents more preferably comprises water, more preferably deionized water. Furthermore, it is preferred that the molar ratio H₂O:YO₂ of the mixture according to step (A) ranges from 5 to 100, more preferably from 10 to 50, more preferably from 13 to 30, more preferably from 15 to 20, and even more preferably from 17 to 18.

It is preferred that the molar ratio M:YO₂ in the mixture according to step (A) ranges from 0.05 to 5, more preferably from 0.1 to 2, more preferably from 0.3 to 1, more preferably from 0.4 to 0.8, more preferably from 0.45 to 0.7, more preferably from 0.5 to 0.65, and even more preferably from 0.55 to 0.6. Furthermore, it is preferred that the molar ratio YO₂:X₂O₃:M molar ratio in the mixture according to step (A) range from (1 to 200): 1:(0.5 to 100), more preferably from (5 to 100): 1:(5 to 75), more preferably from (10 to 50): 1:(8 to 50), more preferably from (15 to 40): 1:(10 to 30), more preferably from (20 to 30): 1:(11 to 20), more preferably from (23 to 25): 1:(12 to 15), and even more preferably from (23.5 to 24): 1:(13 to 14).

It is preferred that the crystallization in step (B) involves heating of the mixture, more preferably at a temperature ranging from 80 to 200° C., more preferably from 90 to 180° C., more preferably from 100 to 160° C., more preferably from 110 to 140° C., and even more preferably from 115 to 130° C.

Furthermore, it is preferred that the crystallization in step (B) is conducted under solvothermal conditions.

Yet further, it is preferred that the crystallization in step (B) involves heating of the mixture fora period ranging from 5 to 200 h, more preferably from 20 to 160 h, more preferably from 60 to 140 h, and even more preferably from 100 to 130 h.

It is preferred that the process further comprises one or more of the following steps of:
(C) isolating the zeolitic material having a BEA-type framework structure obtained in step (B), preferably by filtration; and
(D) optionally washing the zeolitic material having a BEA-type framework structure obtained in step (B) or (C); and/or
(E) optionally drying the zeolitic material having a BEA-type framework structure obtained in step (B), (C), or (D).

It is preferred that the zeolitic material having a BEA-type framework structure formed in step (B) comprises zeolite beta.

It is preferred that the seed crystals comprise a zeolitic material having a BEA-type framework structure as obtainable or obtained according to the process of any one of the particular and preferred embodiments of the present invention, wherein the seed crystals preferably comprise zeolite beta.

It is preferred that the process further comprises one or more of the following steps of:
(F) subjecting the zeolitic material having a BEA-type framework structure obtained in step (B), (C), (D), or (E) to an ion-exchange procedure; and
(G) washing the ion-exchange zeolitic material obtained in step (F); and/or
(H) drying and/or calcining the zeolitic material having a BEA-type framework structure obtained in step (B), (C), (D), (E), (F), or (G).

In cases wherein the process further comprises step (F) of subjecting the zeolitic material having a BEA-type framework structure obtained in step (B), (C), (D), or (E) to an ion-exchange procedure, it is preferred that in (F) at least one ionic non-framework element in the zeolitic material is ion exchanged against H⁺ and/or NH₄⁺, more preferably against NH₄⁺.

In cases wherein in (F) at least one ionic non-framework element in the zeolitic material is ion exchanged against H⁺ and/or NH₄⁺, it is preferred that the at least one ionic non-framework element comprises one or more cations selected from the group consisting of H⁺ and alkali metal cations, the alkali metal cations more preferably being selected from the group consisting of Li, Na, K, Cs, and combinations of two or more thereof, more preferably from the group consisting of Li, Na, K, and combinations of two or more thereof, wherein more preferably the alkali metal cation is Na and/or K, and even more preferably Na, wherein more preferably the at least one ionic non-framework element comprises Na, wherein more preferably the at least one ionic nonframework element is Na.

It is preferred that steps (F) and (G) are repeated one or more times, more preferably three or more times, more preferably two or more times, wherein more preferably steps (F) and (G) are repeated once.

It is preferred that drying in (H) is conducted at a temperature comprised in the range of from 40 to 200° C., more preferably from 60 to 180° C., more preferably from 70 to 170° C., more preferably from 80 to 160° C., more preferably from 90 to 150° C., more preferably from 100 to 140° C., more preferably from 110 to 130° C.

It is preferred that drying in (H) is conducted for a duration comprised in the range of from 0.25 to 48 hours, more preferably from 0.5 to 42 hours, more preferably from 1 to 36 hours, more preferably from 2 to 32 hours, more preferably from 4 to 28 hours, more preferably from 6 to 24 hours, more preferably from 10 to 20 hours, and more preferably from 14 to 18 hours.

It is preferred that calcination in (H) is conducted at a temperature comprised in the range of from 200 to 900° C., more preferably from 300 to 800° C., more preferably from 350 to 750° C., more preferably from 400 to 700° C., more preferably from 450 to 650° C., more preferably from 500 to 600° C., and more preferably from 525 to 575° C.

It is preferred that calcination in (H) is conducted for a duration comprised in the range of from 1 to 10 hours, more preferably from 2 to 8 hours, more preferably from 3 to 7 hours, more preferably from 4 to 6 hours, and more preferably from 4.5 to 5.5 hours.

The present invention also relates to a zeolitic material as obtained and/or obtainable according to the process of any of the particular and preferred embodiments of the present invention.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.

1. A process for the dealumination of a zeolitic material comprising:
(1) providing a zeolitic material having a framework structure comprising Y, X, and O, wherein Y is a tetravalent element and X is a trivalent element;
(2) providing an aqueous solution having a pH of less than 0.1;
(3) treating the zeolitic material provided in (1) with the aqueous solution provided in (2);
(3.i) optionally washing the zeolitic material obtained in (3);
(3.ii) optionally drying the zeolitic material obtained in (3) or (3.i);
(3.iii) optionally calcining the zeolitic material obtained in (3), (3.i), or (3.ii);
(4) treating the zeolitic material obtained in (3), (3.i), (3.ii), or (3.iii) with an aqueous solution or with a solvent system, wherein the aqueous solution or the solvent system have a pH comprised in the range of from 4 to 10, wherein the pH of the aqueous solution or of the solvent system refers to the pH prior to contacting with the zeolitic material for treatment thereof;
(4.i) optionally drying the zeolitic material obtained in (4);
(4.ii) optionally calcining the zeolitic material obtained in (4) or (4.i).

2. The process of embodiment 1, wherein the zeolitic material provided in (1) contains less than
1 wt.-% of ionic non-framework elements other than H⁺ based on 100 wt.-% of the total amount of Y, X, and O contained in the zeolitic material, preferably less than 0.5 wt.-%, more preferably less than 0.1 wt.-%, more preferably less than 0.05 wt.-%, more preferably less than 0.01 wt.-%, more preferably less than 0.005 wt.-%, and more preferably less than 0.001 wt.-%.

3. The process of embodiment 2, wherein the ionic non-framework elements stand for Na, preferably for Na and K, more preferably for Li, Na, and K, more preferably for Li, Na, K, and Cs, more preferably for alkali metal cations, more preferably for alkali and alkaline earth metal cations, and more preferably for metal cations.

4. The process of embodiment 1, wherein the zeolitic material provided in (1) contains one or more metals M, wherein the one or more metals M are selected from the group consisting of alkali metals and alkaline earth metals, including mixtures of two or more thereof, preferably from the group consisting of alkali metals, more preferably from the group consisting of Li, Na, K, Rb, and Cs, including mixtures of two or more thereof, more preferably from the group consisting of Li, Na, and K, including mixtures of two or more thereof, wherein more preferably the one or more metals M comprise Na and/or K, preferably Na, wherein more preferably the one or more metals M consist of Na and/or K, preferably Na.

5. The process of embodiment 4, wherein the zeolitic material provided in (1) contains the one or more alkali or alkaline earth metals in an amount ranging from 0.01 to 25 wt.-% based on 100 wt.-% of the total amount of M, Y, X, and O contained in the zeolitic material, preferably from 0.05 to 20 wt.-%, more preferably from 0.1 to 18 wt.-%, more preferably from 0.5 to 15 wt.-%, more preferably from 1 to 12 wt.-%, more preferably from 2 to 10 wt.-%, more preferably from 3 to 8 wt.-%, and more preferably from 4 to 6 wt.-%.

6. The process of any of embodiments 1 to 5, wherein (3) and (4) optionally including (3.i), (3.ii), (3.iii), (4.i), and/or (4.ii) are repeated at least once with the zeolitic material obtained from step (4), (4.i), or (4.ii), wherein preferably (3) and (4) optionally including (3.i), (3.ii), (3.iii), (4.i), and/or (4.ii) are repeated 1 to 10 times, more preferably 1 to 8 times, more preferably 1 to 6 times, more preferably 1 to 4 times, more preferably 1 to 3 times, more preferably 1 to 2 times, and wherein more preferably (3) and (4) optionally including (3.i), (3.ii), (3.iii), (4.i), and/or (4.ii) are repeated once.

7. The process of any of embodiments 1 to 6, wherein the framework of the zeolitic material provided in (1) has a Y:X molar ratio comprised in the range of from 1 to 100, preferably from 1 to 50, more preferably from 2 to 25, more preferably from 3 to 12, and more preferably from 4 to 6.

8. The process of any of embodiments 1 to 7, wherein Y is selected from the group consisting of Si, Sn, Ti, Zr, Ge, and a mixture of two or more thereof, Y preferably being Si.

9. The process of any of embodiments 1 to 8, wherein X is selected from the group consisting of Al, B, In, Ga, and a mixture of two or more thereof, X preferably being Al.

10. The process of any of embodiments 1 to 9, wherein the framework-type structure of the zeolitic material provided in (1) is selected from the group consisting of AEI, BEA, CHA, DDR, ERI, FAU, FER, GME, HEU, LEV, MEI, MEL, MFI, MOR, and MWW, including mixed structures of two or more thereof, preferably from the group consisting of AEI, BEA, CHA, FAU, FER, MFI, MOR, and MWW, including mixed structures of two or more thereof, more preferably from the group consisting of BEA, CHA, and MOR, including mixed structures of two or more thereof, wherein more preferably the zeolitic material provided in (1) has the BEA and/or CHA framework-type structure, preferably the BEA framework-type structure.

11. The process of any of embodiments 1 to 10, wherein the zeolitic material provided in (1) comprises one or more zeolites of the BEA-type framework structure selected from the group consisting of zeolite beta, beta polymorph B, [B—Si—O]—*BEA, Tschernichite, [Ga—Si O]—*BEA, CIT-6, including mixtures of two or more thereof, wherein preferably the zeolitic material provided in (1) comprises zeolite beta, wherein more preferably the zeolitic material provided in (1) is zeolite beta.

12. The process of any of embodiments 1 to 11, wherein the pH of the aqueous solution provided in (2) is comprised in the range of from −1 to 0.05, preferably from −0.8 to 0, more preferably from −0.7 to −0.03, more preferably from −0.6 to −0.05, more preferably from −0.5 to −0.08, more preferably from −0.4 to −0.1, more preferably −0.3 to −0.13, and more preferably from −0.2 to −0.15, wherein preferably, the pH is determined using a glass pH electrode, wherein more preferably the pH is determined using a glass pH electrode according to ISO 23497:2019, wherein more preferably the pH is determined according to DIN 19268.

13. The process of any of embodiments 1 to 12, wherein the aqueous solution provided in (2) comprises one or more acids having a pKₐ value of less than or equal to 2.5, preferably of less than or equal to 2.3, more preferably of less than or equal to 2, more preferably of less than or equal to 1.8, more preferably of less than or equal to 1.5, more preferably of less than or equal to 1.3, more preferably of less than or equal to 1, more preferably of less than or equal to 0.8, more preferably of less than or equal to 0.5, more preferably of less than or equal to 0.3, more preferably of less than or equal to 0.1, and more preferably of less than or equal to 0.

14. The process of any of embodiments 1 to 13, wherein the one or more acids are selected from the group consisting of mineral and organic acids, including mixtures of two or more thereof, preferably from the group consisting of mineral acids, including mixtures of two or more thereof, more preferably from the group consisting of HCl, HBr, Hl, HClO, HClO₂, HClO₃, HClO₄, H₂SO₄, HSO₃F, HNO₃, H₃PO₄, HSBF₆, HBF₄, HPF₆, including mixtures of two or more thereof, more preferably from the group consisting of HCl, HBr, HClO₄, H₂SO₄, HSO₃F, HNO₃, H₃PO₄, including mixtures of two or more thereof, more preferably from the group consisting of HCl, H Br, H₂SO₄, HNO₃, H₃PO₄, including mixtures of two or more thereof, more preferably from the group consisting of H₂SO₄, HNO₃, H₃PO₄, including mixtures of two or more thereof, wherein more preferably the aqueous solution provided in (2) comprises HNO₃, wherein more preferably the acid contained in the aqueous solution provided in (2) consists of HNO₃, wherein more preferably the aqueous solution provided in (2) consists of distilled water and HNO₃.

15. The process of embodiment 13 or 14, wherein the total concentration of the one or more acids comprised in the aqueous solution provided in (2) is equal to or greater than 0.8 mol/L, wherein preferably the total concentration of the one or more acids comprised in the aqueous solution provided in (2) is comprised in the range of from 0.8 to 10 mol/L, more preferably of from 1.0 to 10 mol/L, more preferably of from 1.0 to 7.9 mol/L, more preferably of from 1.0 to 6.3 mol/L, more preferably of from 1.1 to 2.5 mol/L, more preferably of from 1.1 to 1.6 mol/L, and more preferably of from 1.1 to 1.4 mol/L.

16. The process of any of embodiments 1 to 15, wherein the molar ratio H₂O:Y of the molar amount of H₂O in the aqueous solution provided in (2) which is used for treating in (3) to the molar amount of Y in the framework structure of the zeolitic material which is treated in (3) is comprised in the range of from 1 to 200, preferably from 3 to 150, more preferably from 5 to 50, more preferably from 7 to 25, more preferably from 8 to 15, more preferably from 8.5 to 12, more preferably from 9 to 11, and more preferably from 9.5 to 10.5.

17. The process of any of embodiments 1 to 16, wherein the treatment in (3) is conducted at a temperature comprised in the range of from 20 to 100° C., preferably from 30 to 90° C., more preferably from 40 to 80° C., more preferably from 50 to 70° C., more preferably from 55 to 65° C., more preferably from 58 to 62° C., and more preferably from 59 to 61° C.

18. The process of any of embodiments 1 to 17, wherein the treatment in (3) is conducted for a duration comprised in the range of from 40 to 200 minutes, preferably from 60 to 180 minutes, more preferably from 70 to 170 minutes, more preferably from 80 to 160 minutes, more preferably from 90 to 150 minutes, more preferably from 100 to 140 minutes, and more preferably from 110 to 130 minutes, and more preferably from 115 to 125 minutes.

19. The process of any of embodiments 1 to 18, wherein optional washing in (3.i) is performed with distilled water.

20. The process of any of embodiments 1 to 19, wherein optional drying in (3.ii) is conducted at a temperature comprised in the range of from 40 to 200° C., preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.

21. The process of any of embodiments 1 to 20, wherein optional drying in (3.ii) is conducted for a duration comprised in the range of from 0.25 to 48 hours, preferably from 0.5 to 36 hours, more preferably from 1 to 30 hours, more preferably from 2 to 24 hours, more preferably from 4 to 20 hours, more preferably from 6 to 18 hours, more preferably from 8 to 16 hours, more preferably from 10 to 14 hours, and more preferably from 11 to 13 hours.

22. The process of any of embodiments 1 to 21, wherein optional calcination in (3.iii) is conducted at a temperature comprised in the range of from 300 to 900° C., preferably from 350 to 850° C., more preferably from 400 to 800° C., more preferably from 450 to 750° C., more preferably from 500 to 700° C., more preferably from 550 to 650° C., more preferably from 590 to 610° C., and more preferably from 598 to 602° C.

23. The process of any of embodiments 1 to 22, wherein optional calcination in (3.iii) is conducted for a duration comprised in the range of from 1 to 10 hours, preferably from 2 to 8 hours, more preferably from 3 to 7 hours, more preferably from 4 to 6 hours, and more preferably from 4.5 to 5.5 hours.

24. The process of any of embodiments 1 to 23, wherein the pH of the aqueous solution or of the solvent system employed for the treatment in (4) is comprised in the range of from 4 to 10, preferably from 5 to 9, more preferably from 6 to 8, more preferably from 6.5 to 7.5, and more preferably from 6.8 to 7.2, wherein the pH of the aqueous solution or of the solvent system refers to the pH prior to contacting with the zeolitic material for treatment thereof.

25. The process of any of embodiments 1 to 24, wherein the solvent system employed in (4) comprises water, wherein the solvent system employed in (4) preferably consists of distilled water.

26. The process of any of embodiments 1 to 25, wherein treatment in (4) is conducted at a temperature comprised in the range of from 30 to 150° C., preferably from 40 to 140° C., more preferably from 50 to 130° C., more preferably from 60 to 120° C., more preferably from 70 to 110° C., more preferably from 80 to 100° C., more preferably from 85 to 95° C., and more preferably from 88 to 92° C.

27. The process of any of embodiments 1 to 26, wherein treatment in (4) is conducted for a duration comprised in the range of from 1 to 17 hours, preferably from 2 to 16 hours, more preferably 3 to 15 hours, more preferably from 5 to 13 hours, more preferably from 6 to 12 hours, more preferably from 7 to 11 hours, more preferably from 8 to 10 hours, and more preferably from 8.5 to 9.5 hours.

28. The process of any of embodiments 1 to 27, wherein the solvent system comprises water, and wherein the molar ratio H₂O:Y of the molar amount of H₂O in the aqueous solution or in the solvent system used for treating in (3) to the molar amount of Y in the framework structure of the zeolitic material which is treated in (3) is comprised in the range of from 1 to 250, preferably from 2.5 to 200, more preferably from 5 to 150, more preferably from 10 to 100, more preferably from 15 to 50, more preferably from 20 to 30, more preferably from 21 to 26, and more preferably from 22 to 24.

29. The process of any of embodiments 1 to 28, wherein optional drying in (4.i) is conducted at a temperature comprised in the range of from 40 to 200° C., preferably from 50 to 190° C., more preferably from 60 to 180° C., more preferably from 70 to 170° C., more preferably from 80 to 160° C., more preferably from 90 to 150° C., more preferably from 100 to 140° C., more preferably from 110 to 130° C., more preferably from 115 to 125° C., and more preferably from 118 to 122° C.

30. The process of any of embodiments 1 to 29, wherein optional drying in (4.i) is conducted for a duration comprised in the range of from 0.25 to 48 hours, preferably from 0.5 to 36 hours, more preferably from 1 to 30 hours, more preferably from 2 to 24 hours, more preferably from 4 to 20 hours, more preferably from 6 to 18 hours, more preferably from 8 to 16 hours, more preferably from 10 to 14 hours, and more preferably from 11 to 13 hours.

31. The process of any of embodiments 1 to 30, wherein optional calcination in (4.ii) is conducted at a temperature comprised in the range of from 200 to 1000° C., preferably from 300 to 900° C., more preferably from 350 to 850° C., more preferably from 400 to 800° C., more preferably from 450 to 750° C., more preferably from 500 to 700° C., more preferably from 550 to 650° C., more preferably from 575 to 625° C., and more preferably 595 to 605° C.

32. The process of any of embodiments 1 to 31, wherein optional calcination in (4.ii) is conducted for a duration comprised in the range of from 1 to 10 hours, preferably from 2 to 8 hours, more preferably from 3 to 7 hours, more preferably from 4 to 6 hours, and more preferably from 4.5 to 5.5 hours.

33. The process of any of embodiments 1 to 32, wherein the zeolitic material provided in (1) is obtainable or obtained from an organo-template-free synthetic process.

34. The process of embodiment 33, wherein the organo-template-free synthetic process comprises
(A) preparing a mixture comprising one or more sources for YO₂, one or more sources for X₂O₃, and seed crystals comprising one or more zeolitic materials having a BEA-type framework structure; and
(B) crystallizing the mixture obtained in step (A) for forming a zeolitic material having a BEA-type framework structure;
   wherein Y is a tetravalent element, and X is a trivalent element, and
   wherein the mixture provided in step (A) and crystallized in step (B) does not contain an organo-template as structure-directing agent.

35. The process of embodiment 34, wherein the zeolitic material obtained in step (B) comprises one or more alkali metals M, wherein M is preferably selected from the group consisting of Li, Na, K, Cs, and combinations of two or more thereof, more preferably from the group consisting of Li, Na, K, and combinations of two or more thereof, wherein more preferably the alkali metal M is Na and/or K, even more preferably Na.

36. The process of any of embodiment 34 or 35, wherein Y is selected from the group consisting of Si, Sn, Ti, Zr, Ge, and a mixture of two or more thereof, Y preferably being Si.

37. The process of any of embodiments 34 to 36, wherein the one or more sources for YO₂ provided in step (A) comprises one or more silicates, preferably one or more alkali metal silicates, wherein the alkali metal is preferably selected from the group consisting of Li, Na, K, Rb, and Cs, wherein more preferably the alkali metal is Na and/or K, and wherein even more preferably the alkali metal is Na.

38. The process of embodiment 37, wherein the one or more sources for YO₂ further comprises one or more silicas in addition to the one or more silicates, preferably one or more silica hydrosols and/or one or more colloidal silicas, and even more preferably one or more colloidal silicas in addition to the one or more silicates.

39. The process of embodiment 37 or 38, wherein the mixture provided in step (A) comprises water glass, preferably sodium and/or potassium silicate, more preferably sodium silicate.

40. The process of any of embodiments 34 to 39, wherein X is selected from the group consisting of Al, B, In, Ga, and a mixture of two or more thereof, X preferably being Al.

41. The process of any of embodiments 34 to 40, wherein the one or more sources for X₂O₃ comprises one or more aluminate salts, preferably an aluminate of an alkali metal, wherein the alkali metal is preferably selected from the group consisting of Li, Na, K, Rb, and Cs, wherein more preferably the alkali metal is Na and/or K, and wherein even more preferably the alkali metal is Na.

42. The process of any of embodiments 34 to 41, wherein the molar ratio YO₂:X₂O₃ of the mixture according to step (A) ranges from 1 to 200, preferably from 5 to 100, more preferably from 10 to 50, more preferably from 15 to 40, more preferably from 20 to 30, more preferably from 23 to 25, and even more preferably from 23.5 to 24.

43. The process of any of embodiments 34 to 42, wherein the amount of seed crystals comprised in the mixture according to step (A) ranges from 0.1 to 30 wt.-% based on 100 wt.-% of YO₂ in the one or more sources for YO₂, preferably from 0.5 to 20 wt.-%, more preferably from 1 to 10 wt.-%, more preferably from 1.5 to 5 wt.-%, more preferably from 2 to 4 wt.-%, and even more preferably from 2.5 to 3.5 wt.-%.

44. The process of any of embodiments 34 to 43, wherein the mixture according to step (A) further comprises one or more solvents, wherein said one or more solvents preferably comprises water, more preferably deionized water.

45. The process of embodiment 44, wherein the molar ratio H₂O:YO₂ of the mixture according to step (A) ranges from 5 to 100, preferably from 10 to 50, more preferably from 13 to 30, more preferably from 15 to 20, and even more preferably from 17 to 18.

46. The process of any of embodiments 34 to 45, wherein the molar ratio M:YO₂ in the mixture according to step (A) ranges from 0.05 to 5, preferably from 0.1 to 2, more preferably from 0.3 to 1, more preferably from 0.4 to 0.8, more preferably from 0.45 to 0.7, more preferably from 0.5 to 0.65, and even more preferably from 0.55 to 0.6.

47. The process of embodiment 46, wherein the molar ratio YO₂:X₂O₃:M molar ratio in the mixture according to step (A) range from (1 to 200): 1:(0.5 to 100), preferably from (5 to 100): 1:(5 to 75), more preferably from (10 to 50): 1:(8 to 50), more preferably from (15 to 40): 1:(10 to 30), more preferably from (20 to 30): 1:(11 to 20), more preferably from (23 to 25): 1:(12 to 15), and even more preferably from (23.5 to 24): 1:(13 to 14).

48. The process of embodiments 35 to 47, wherein the crystallization in step (B) involves heating of the mixture, preferably at a temperature ranging from 80 to 200° C., more preferably from 90 to 180° C., more preferably from 100 to 160° C., more preferably from 110 to 140° C., and even more preferably from 115 to 130° C.

49. The process of embodiment 48, wherein the crystallization in step (B) is conducted under solvothermal conditions.

50. The process of embodiments 48 or 49, wherein the crystallization in step (B) involves heating of the mixture for a period ranging from 5 to 200 h, more preferably from 20 to 160 h, more preferably from 60 to 140 h, and even more preferably from 100 to 130 h.

51. The process of any of embodiments 34 to 50, wherein the process further comprises one or more of the following steps of:
(C) isolating the zeolitic material having a BEA-type framework structure obtained in step (B), preferably by filtration; and
(D) optionally washing the zeolitic material having a BEA-type framework structure obtained in step (B) or (C); and/or
(E) optionally drying the zeolitic material having a BEA-type framework structure obtained in step (B), (C), or (D).

52. The process of any of embodiments 34 to 51, wherein the zeolitic material having a BEA-type framework structure formed in step (B) comprises zeolite beta.

53. The process of any of embodiments 34 to 52, wherein the seed crystals comprise a zeolitic material having a BEA-type framework structure as obtainable or obtained according to the process of any one of embodiments 30 to 48, wherein the seed crystals preferably comprise zeolite beta.

54. The process of any of embodiments 34 to 53, wherein the process further comprises one or more of the following steps of:
(F) subjecting the zeolitic material having a BEA-type framework structure obtained in step (B), (C), (D), or (E) to an ion-exchange procedure; and
(G) washing the ion-exchange zeolitic material obtained in step (F); and/or
(H) drying and/or calcining the zeolitic material having a BEA-type framework structure obtained in step (B), (C), (D), (E), (F), or (G).

55. The process of embodiment 54, wherein in (F) at least one ionic non-framework element in the zeolitic material is ion exchanged against H⁺ and/or NH₄⁺, preferably agains NH₄⁺.

56. The process of embodiment 55, wherein the at least one ionic non-framework element comprises one or more cations selected from the group consisting of H⁺ and alkali metal cations, the alkali metal cations preferably being selected from the group consisting of Li, Na, K, Cs, and combinations of two or more thereof, more preferably from the group consisting of Li, Na, K, and combinations of two or more thereof, wherein more preferably the alkali metal cation is Na and/or K, and even more preferably Na, wherein more preferably the at least one ionic non-framework element comprises Na, wherein more preferably the at least one ionic non-framework element is Na.

57. The process of any of embodiments 54 to 56, wherein steps (F) and (G) are repeated one or more times, preferably three or more times, more preferably two or more times, wherein more preferably steps (F) and (G) are repeated once.

58. The process of any of embodiments 54 to 57, wherein drying in (H) is conducted at a temperature comprised in the range of from 40 to 200° C., preferably from 60 to 180° C., more preferably from 70 to 170° C., more preferably from 80 to 160° C., more preferably from 90 to 150° C., more preferably from 100 to 140° C., more preferably from 110 to 130° C.

59. The process of any of embodiments 54 to 58, wherein drying in (H) is conducted for a duration comprised in the range of from 0.25 to 48 hours, preferably from 0.5 to 42 hours, more preferably from 1 to 36 hours, more preferably from 2 to 32 hours, more preferably from 4 to 28 hours, more preferably from 6 to 24 hours, more preferably from 10 to 20 hours, and more preferably from 14 to 18 hours.

60. The process of any of embodiments 54 to 59, wherein calcination in (H) is conducted at a temperature comprised in the range of from 200 to 900° C., preferably from 300 to 800° C., more preferably from 350 to 750° C., more preferably from 400 to 700° C., more preferably from 450 to 650° C., more preferably from 500 to 600° C., and more preferably from 525 to 575° C.

61. The process of any of embodiments 54 to 60, wherein calcination in (H) is conducted for a duration comprised in the range of from 1 to 10 hours, preferably from 2 to 8 hours, more preferably from 3 to 7 hours, more preferably from 4 to 6 hours, and more preferably from 4.5 to 5.5 hours.

62. A zeolitic material as obtained and/or obtainable according to the process of any of embodiments 1 to 61.

### EXPERIMENTAL SECTION

### Reference Example 1: Determination of the Crystallinity

Powder X-ray diffraction (PXRD) data was collected using a diffractometer (D8 Advance Series II, Bruker AXS GmbH) equipped with a LYNXEYE detector operated with a Copper anode X-ray tube running at 40 kV and 40 mA. The geometry was Bragg-Brentano, and air scattering was reduced using an air scatter shield. The crystallinity was determined using DIFFRAC.EVA software (User Manual for DIFFRAC.EVA, Bruker AXS GmbH, Karlsruhe).

### Reference Example 2: General Procedure for the Dealumination of a Zeolitic Material

Generally, four different treatment steps were used in the dealumination procedure, with variation in the number of repetitions and order of the treatment steps:
1. (Acid) dealumination: the zeolite powder is suspended in an acid solution (solids:liquid ratio 1:3; e.g. 50 g of zeolite powder suspended in 150 g of aqueous HNO₃) and heated to the desired temperature. After the specified treatment duration, the suspension was left to cool down, and filtered and washed over a porcelain filter until the pH of the filtrate was neutral (for H₃PO₄ and H₂SO₄ acid treatments), or until no NO₃⁻ was detected with nitrate test paper (Merck KGaA). Unless specified otherwise, the treatment temperature and duration were 60° C. for 2 h.
2. Drying: drying of the filtercake was performed overnight in a convection oven at 120° C.
3. Water treatment: the zeolite powder was suspended in water in a 4-neck round bottom flask of 1 L and heated under reflux to 90° C. for 9 h using an electrical heating jacket, followed by filtration of the suspension and drying (overnight at 120° C.)
4. Calcination: Unless specified otherwise, the dried zeolite powder was calcined in air in a calcination static oven with a temperature ramp of 2° C./min to 600° C. for 5 h.

### Reference Example 3: Organo-Template-Free Synthesis of a Zeolitic Material in the Na-from

335.1 g of NaAlO₂ were dissolved in 7314 g of H₂O while stirring, followed by addition of 74.5 g of zeolite Beta seeds (commercially available from Zeolyst International, Valley Forge, PA 19482, USA, under the tradename CP814C, CAS Registry Number 1318-02-1). The mixture was placed in a 20 L autoclave and 7340 g sodium waterglass and 1436 g Ludox AS40 were added. Crystallization of the obtained aluminosilicate gel took place at 120° C. for 117 h. After having let the reaction mixture cool to room temperature, the solid was separated by filtration, repeatedly washed with distilled water and then dried at 120° C. for 16 h. The resulting material had a water uptake of 12 weight-%.

### Reference Example 4: Organo-Template-Free Synthesis of a Zeolitic Material in the H-from

For the preparation of the H-form, 1000 g of zeolitic material prepared according to Reference Example 3 were added to 10 g of a 10 wt.-% solution of ammonium nitrate. The suspension was heated to 80° C. and kept at this temperature under continuous stirring for 2 h. The solid was filtered hot (without additional cooling) over a filter press. The filter cake was then washed with distilled water (room temperature wash water) until the conductivity of the wash water was below 200 microSiemens/cm. The filter cake was dried for 16 h at 120° C. This procedure was repeated once, affording ion exchanged crystalline product BEA in its ammonium form. A following calcination step at 500° C. for 5 h (heat ramp 1° C./min) afforded ion exchanged crystalline product BEA in its H-form.

### Comparative Example 1: Dealumination of Zeolite Beta with an Acid of a Conventional Concentration

Zeolite beta as obtained from the organo-template free synthesis of Reference Example 4 was dealuminated according to the method described in Reference Example 2 using 4% HNO₃ (pH=0.19 as measured at 20° C. according to DIN 19268), wherein after dealumination according to step 1, the material was dried according to step 2, calcined according to step 4, treated with water according to step 3 (zeolite powder was suspended in water at a solids:liquid ratio of 1:7), and finally dried again according to step 2. The entire sequence of steps was then repeated once for providing a dealuminated zeolite beta with an SiO₂:Al₂O₃ molar ratio of 19 and a crystallinity of 73%.

### Example 1: Dealumination of Zeolite Beta with a Highly Concentrated Acid

Zeolite beta as obtained from the organo-template free synthesis of Reference Example 4 was dealuminated according to the method described in Reference Example 2 using 8% HNO₃ (pH=−0.17 as measured at 20° C. according to DIN 19268), wherein after dealumination according to step 1, the material was dried according to step 2, treated with water according to step 3 (zeolite powder was suspended in water at a solids:liquid ratio of 1:10), and finally dried again according to step 2. The procedure provided a dealuminated zeolite beta with an SiO₂:Al₂O₃ molar ratio of 17.4 and a crystallinity of 76%.

### Example 2: Dealumination of Zeolite Beta with a Highly Concentrated Acid

Zeolite beta as obtained from the organo-template free synthesis of Reference Example 4 was dealuminated according to the method described in Reference Example 2 using 8% HNO₃ (pH=−0.17 as measured at 20° C. according to DIN 19268), wherein after dealumination according to step 1, the material was dried according to step 2, treated with water according to step 3 (zeolite powder was suspended in water at a solids:liquid ratio of 1:10), and finally dried again according to step 2. The entire sequence of steps was then repeated once for providing a dealuminated zeolite beta with an SiO₂:Al₂O₃ molar ratio of 61 and a crystallinity of 80%.

### Example 3: Dealumination of Zeolite Beta with a Highly Concentrated Acid

Zeolite beta as obtained from the organo-template free synthesis of Reference Example 4 was dealuminated according to the method described in Reference Example 2 using 8% HNO₃ (pH=−0.17 as measured at 20° C. according to DIN 19268), wherein after dealumination according to step 1, the material was dried according to step 2, treated with water according to step 3 (zeolite powder was suspended in water at a solids:liquid ratio of 1:10), dried again according to step 2, and finally calcined according to step 4. The entire sequence of steps was then repeated once for providing a dealuminated zeolite beta with an SiO₂:Al₂O₃ molar ratio of 64 and a crystallinity of 80%.

Accordingly, as may be taken from the results obtained in Example 1 and Comparative Example 1, it has surprisingly been found that by employing a highly concentrated acid, the same level of dealumination may be achieved with only one dealumination step as when using an acid of a conventional concentration in a process involving 2 steps of dealumination. In particular it has quite unexpectedly been found that despite the use of a highly concentrated acid in the inventive process, the loss of crystallinity is comparable, if not even less pronounced than when using an acid of a conventional concentration for the dealumination step.

Furthermore, it has quite surprisingly been found that by repeating the inventive procedure once a highly dealuminated zeolitic material may be obtained, wherein again it has quite unexpectedly been found that even after repeated dealumination step with a highly concentrated acid, the loss of crystallinity is comparable, if not even less pronounced, compared to the repetition of the procedure with an acid of a conventional concentration which by far does not achieve the same level of dealumination in the resulting material. Yet further, as shown by the comparison of the results from Comparative Example 1 and Example 1, as well as of those from Examples 2 and 3, respectively, it has quite surprisingly been found that said unexpected results may even be achieved without the use of a calcination step in the procedure, thus affording an yet higher level of time- and cost-efficiency compared to a procedure according to Comparative Example 1.

### CITED LITERATURE

EP 0 013 433 A1
WO 02/057181 A2
WO 2009/016153 A2
WO 2012/137132 A1
WO 2014/060260 A1

1. A process for the dealumination of a zeolitic material comprising:
(1) providing a zeolitic material having a framework structure comprising Y, X, and O, wherein Y is a tetravalent element and X is a trivalent element;
(2) providing an aqueous solution having a pH of less than 0.1;
(3) treating the zeolitic material provided in (1) with the aqueous solution provided in (2);
(3.i) optionally washing the zeolitic material obtained in (3);
(3.ii) optionally drying the zeolitic material obtained in (3) or (3.i);
(3.iii) optionally calcining the zeolitic material obtained in (3), (3.i), or (3.ii);
(4) treating the zeolitic material obtained in (3), (3.i), (3.ii), or (3.iii) with an aqueous solution or with a solvent system, wherein the aqueous solution or the solvent system have a pH comprised in the range of from 4 to 10, wherein the pH of the aqueous solution or of the solvent system refers to the pH prior to contacting with the zeolitic material for treatment thereof;
(4.i) optionally drying the zeolitic material obtained in (4); and
(4.ii) optionally calcining the zeolitic material obtained in (4) or (4.i).

2. The process of claim 1, wherein the zeolitic material provided in (1) contains less than 1 wt.-% of ionic non-framework elements other than H⁺ based on 100 wt.-% of the total amount of Y, X, and O contained in the zeolitic material.

3. The process of claim 2, wherein the ionic non-framework elements stand for Na.

4. The process of claim 1, wherein the zeolitic material provided in (1) contains one or more metals M, wherein the one or more metals M are selected from the group consisting of alkali metals and alkaline earth metals, including mixtures of two or more thereof.

5. The process of claim 4, wherein the zeolitic material provided in (1) contains the one or more alkali or alkaline earth metals in an amount ranging from 0.01 to 25 wt.-% based on 100 wt.-% of the total amount of M, Y, X, and O contained in the zeolitic material.

6. The process of claim 1, wherein Y is selected from the group consisting of Si, Sn, Ti, Zr, Ge, and a mixture of two or more thereof.

7. The process of claim 1, wherein X is selected from the group consisting of Al, B, In, Ga, and a mixture of two or more thereof.

8. The process of claim 1, wherein the framework-type structure of the zeolitic material provided in (1) is selected from the group consisting of AEI, BEA, CHA, DDR, ERI, FAU, FER, GME, HEU, LEV, MEI, MEL, MFI, MOR, and MWW, including mixed structures of two or more thereof.

9. The process of claim 1, wherein the zeolitic material provided in (1) comprises one or more zeolites of the BEA-type framework structure selected from the group consisting of zeolite beta, beta polymorph B, [B—Si—O]—*BEA, Tschernichite, [Ga—Si—O]BEA, CIT-6, including mixtures of two or more thereof.

10. The process of claim 1, wherein the pH of the aqueous solution provided in (2) is comprised in the range of from −1 to 0.05.

11. The process of claim 1, wherein the aqueous solution provided in (2) comprises one or more acids having a pKₐ value of less than or equal to 2.5.

12. The process of claim 1, wherein the treatment in (3) is conducted for a duration comprised in the range of from 40 to 200 minutes.

13. The process of claim 1, wherein the pH of the aqueous solution or of the solvent system employed for the treatment in (4) is comprised in the range of from 4 to 10, wherein the pH of the aqueous solution or of the solvent system refers to the pH prior to contacting with the zeolitic material for treatment thereof.

14. The process of claim 1, wherein the zeolitic material provided in (1) is obtainable or obtained from an organo-template-free synthetic process.

15. A zeolitic material as obtained and/or obtainable according to the process of claim 1.
